(19) United States
(12) Patent Application Publication
(10) Pub. No.: US 2018/0150883 A1
(43) Pub. Date: May 31, 2018

(54) CONTENT SELECTION FOR INCREMENTAL USER RESPONSE LIKELIHOOD

(71) Applicant: Facebook, Inc., Menlo Park, CA (US)

(72) Inventors: Joseph Poj Davin, Daly City, CA (US); William Bullock, Palo Alto, CA (US); Erjie Ang, Sunnyvale, CA (US)

(21) Appl. No.: 15/365,849

(22) Filed: Nov. 30, 2016

(51) Int. Cl. G06Q 30/02; G06N 99/00

(52) U.S. Cl. CPC G06Q 30/0269; G06N 99/005

(57) ABSTRACT

An online system provides content items to target users who are identified to have high incremental likelihood of performing conversion actions when presented with content items. The incremental likelihood represents the difference between the response likelihood of performing conversion actions when a content item is presented to a user, and the baseline likelihood when a content item is not presented to the user. The baseline and response likelihood for a user are predicted by one or more machine-learned models. By targeting the content to users that are likely to have a high incremental likelihood, the online system provides content items to users whose conversion actions are more likely to be impacted by the presentation of content items, rather than users that may just be of interest for performing the action.

### BACKGROUND

This invention relates generally to identifying users of an online system likely to change behavior based on content item exposure, and more particularly to using computer modeling of user attributes and behavior to predict the likelihood of change in behavior.

For many content items provided by an online system, a content item is intended to cause users viewing the content item to perform a desired action. For example, a user may add a connection on a social networking system responsive to seeing an informational item for adding a connection. Another user may execute an online purchase of a product through a third-party website in response to viewing a content item promoting the product. As another example, a user may leave a message to the business entity that indicates the user is interested in the product. To increase the frequency of such user actions, content providers target the content items to users defined by a set of targeting criteria.

However, often the content providers do not (and typically cannot) take into account the actual impact of the content items in promoting the user actions when selecting targeting criteria, and provide content items to some users who are not likely to change user actions regardless of viewing the content items and conversely will target users that already are likely to perform the action. For example, a user may purchase a certain brand of beverage regardless of viewing a content item promoting the beverage. As another example, a user may not purchase a product regardless of viewing a content item promoting the product.

Display space on a user's device is limited, so evaluating the correct users to target for content items avoids displaying the content item to users unlikely to be affected by the content item in performing the desired action, and poor targeting of a content item may cause that content item to compete with and displace other content items for the limited display space.

### SUMMARY

An online system, such as a social networking system, identifies users who have high incremental likelihood of performing a desired action when presented with a content item. The desired action is also termed a conversion or a conversion action. The incremental likelihood represents the difference between the response likelihood of performing conversion actions when a content item is presented to a user, and the baseline likelihood when a content item is not presented to the user. The baseline and response likelihood for a user are predicted by one or more machine-learned models. After identifying the users that have high incremental likelihood, those users, and others like them, may be selected for targeting (or adjusting the targeting of) the content.

Specifically, the online system selects a control group and a test group of users from the online system. The initial control and test group may be selected from an initial set of targeting criteria (or target users) for the content item, such as users from whom the action is desired. Sponsored content items are provided to at least some users of test group, termed the impression group, and are not provided to users in the control group.

In one embodiment, to actually be shown to a user, a content item competes with other content items for placement, for example based on an expected value of a user viewing the content item, which may account for a prediction of a user's interaction with the content item. In this embodiment, for the control group, the content item does not compete for placement. For the test group, the content item may compete for placement, and the when the content item is placed, the impression group includes users from the test group to whom the content item was displayed. In this way, the initial set of target users (e.g., the originally desired users to perform the action) may be separated to a set of users that the content item does not compete to be placed to, and users for whom the content item competed, and won placement to.

Conversion actions are received for users of the control group and the impression group. For each group of users (the impression group and the control group), one or more machine-learned models are trained on the users in that group to predict a likelihood of conversion action based on user characteristics. For the control group, the machine-learned models predict a baseline likelihood for a user to perform the conversion action by training on the actions and characteristics of users in the control group. Likewise, for the impression group, the machine learned models predicts a response likelihood for a user to perform the conversion action by training on the actions and characteristics of users in the impression group. For a given user, a prediction from each model may be used to predict that user's likelihood of performing the action without viewing the content item (the baseline likelihood prediction) and after viewing the content item (the response likelihood prediction). For the given user, an incremental likelihood is determined that is the difference between the response likelihood prediction and the baseline likelihood prediction for the user. The incremental likelihood represents the increase in likelihood that the user will perform the conversion action after viewing the content item compared to when the user has not viewed the content item. Thus, the incremental likelihood also represents the impact of the content item on the user to perform the conversion action.

After determining the incremental likelihoods for one or more users, the online system may use the predicted incremental likelihood to target delivery of the content item. For example, the online system provides content items associated with the content providers to users having incremental likelihoods that meet predetermined criteria. Alternatively, incremental likelihoods may be determined for a set of users (e.g., the set of users from the control and test groups) and the set of users may be ranked according to the incremental likelihood of conversion. A percentage of the ranked set (e.g., the top 30%) may be selected and used to define targeting criteria or otherwise identify other users that are similar to the selected users for targeting delivery of the content item. By doing so, the online system provides content items to those users whose conversion actions are more likely to be impacted by the presentation of the content items.

### BRIEF DESCRIPTION OF THE DRAWINGS

FIG. 1 is a high level block diagram of a system environment for an online system, such as a social networking system, in accordance with an embodiment.

FIG. 2 is an example block diagram of an architecture of the online system, in accordance with an embodiment.

FIG. 3 is an example process of determining incremental likelihoods for users of the online system for a content item, in accordance with an embodiment.

FIG. 4 is an example block diagram of an architecture of the content provider system, in accordance with an embodiment.

FIGS. 5A and 5B illustrate example training data for an impression group and a test group, in accordance with an embodiment.

FIG. 6 shows example data of predicted baseline likelihoods, response likelihoods, and incremental likelihoods for users of the online system, in accordance with an embodiment.

FIG. 7 is a flowchart illustrating a process of training machine-learned models for predicting baseline and response likelihoods, in accordance with an embodiment.

FIG. 8 is a flowchart illustrating a process of providing content items to users having high incremental likelihoods, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

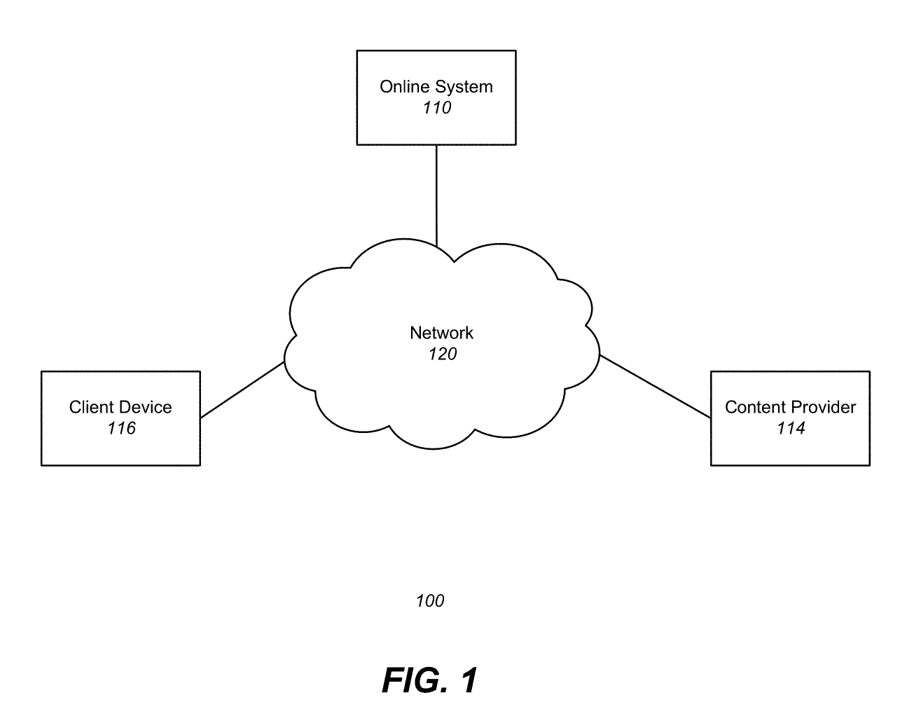

FIG. 1 is a high level block diagram of a system environment for an online system, such as a social networking system, in accordance with an embodiment. The online system 110 provides various content items to users of the online system 110 and identifies when users perform various actions. The online system 110 determines an increased likelihood of performing a desired action responding to a content item for a user based on machine-learned models for users that did and did not view the content item. The system environment 100 shown by FIG. 1 includes one or more client devices 116, a network 120, one or more content providers 114, and the online system 110. In alternative configurations, different and/or additional components may be included in the system environment 100. The embodiments described herein can be adapted to online systems that are not social networking systems and provide various types of content items to users and measure resulting desired actions, such as advertising systems or ad publishing systems.

One or more content providers 114 may be coupled to the network 120 for communicating with the online system 110. The content providers 114 are one or more entities interested in promoting a desired action associated with a content item. The desired action is also termed a conversion or a conversion action. The subject of the content item may be, for example, a product, a cause, or an event. The content providers 114 may be a sponsoring entity, such a company, associated with the content item that owns or manages the subject of the content item, or may be an agency hired by the sponsoring entity to promote the subject of the content item. In one embodiment referred to throughout the application, a content item may be an advertisement or other promotional content items for performing the desired action, and may be provided by an advertiser, but is not limited thereto. For example, the content item may be provided by the online system 110 itself, and the content items may encourage engagement with the online system 110, or provide for other actions to be performed by users.

The content providers 114 provide one or more content item requests (“item requests”) to the online system 110 that include content items to be served to the client devices 116 along with various optional parameters associated with the content items that determine how the content items will be presented. For example, the item requests provided by the content providers 114 may include a content item and targeting criteria specified by the content providers 114 that indicate characteristics of users that are to be presented with the content item. As another example, the item requests may also include a value representing how much a user's desired action is worth to the content providers 114. The item requests are stored in the online system 110.

The client device 116 is a computing device that displays information to a user and communicates user actions to various systems across the network 120. While a single client device 116 is illustrated in FIG. 1, in practice many client devices 116 may communicate with the systems in environment 100. In one embodiment, a client device 116 is a conventional computer system, such as a desktop or laptop computer. Alternatively, a client device 116 may be a device having computer functionality, such as a personal digital assistant (PDA), a mobile telephone, a smartphone or another suitable device. A client device 116 is configured to communicate via the network 120. In one embodiment, a client device 116 executes an application allowing a user of the client device 116 to interact with the online system 110. For example, a client device 116 executes a browser application to enable interaction between the client device 116 and the online system 110 via the network 120. In another embodiment, the client device 116 interacts with the online system 110 through an application programming interface (API) running on a native operating system of the client device 116, such as IOS® or ANDROID™.

The various devices communicate via the network 120, which may comprise any combination of local area and/or wide area networks, using both wired and/or wireless communication systems. For example, the online system 110 may provide content to the client device 116 and identify actions performed by users transmitted to the online system 110.

### Online System

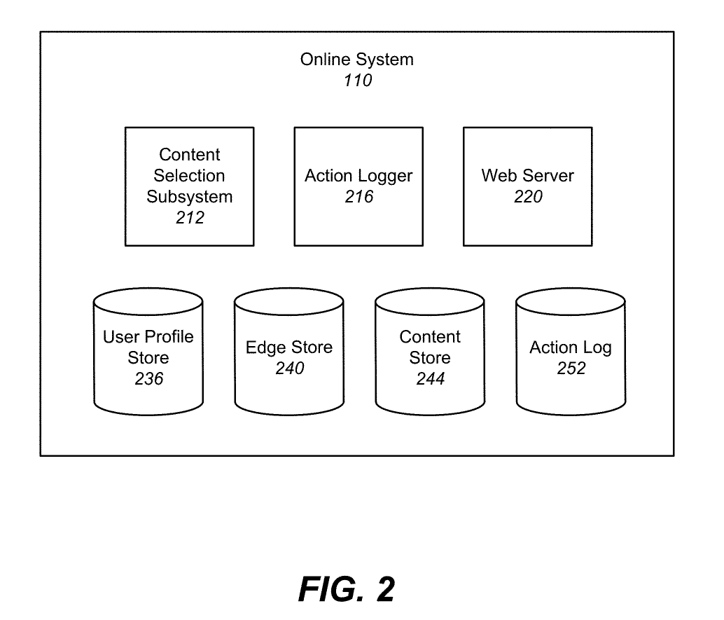

FIG. 2 is an example block diagram of an architecture of the online system 110, in accordance with an embodiment. The online system 110 shown in FIG. 2 includes a user profile store 236, an edge store 240, a social content store 244, an action log 252, a content selection subsystem 212, and an action logger 216. In other embodiments, the online system 110 may include additional, fewer, or different components for various applications. Conventional components such as network interfaces, security functions, load balancers, failover servers, management and network operations consoles, and the like are not shown so as to not obscure the details of the system architecture. In the example provided below, the online system 110 includes various social networking and sponsored content components, though other embodiments may not relate to social networking or may not relate to sponsored content.

Each user of the online system 110 is associated with a user profile, which is stored in the user profile store 236. A user profile includes declarative information about the user that was explicitly shared by the user and may also include profile information inferred by the online system 110. In one embodiment, a user profile includes multiple data fields, each describing one or more attributes of the corresponding user of the online system 110. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 110 displayed in an image. A user profile in the user profile store 236 may also maintain references to actions by the corresponding user performed on content items in the social content store 244 and are stored in the action log 252.

While user profiles in the user profile store 236 are frequently associated with individuals, allowing individuals to interact with each other via the online system 110, user profiles may also be stored for entities such as businesses or organizations. This allows an entity to establish a presence on the online system 110 for connecting and exchanging content with other online system 110 users. The entity may post information about itself, about its products or provide other information to users of the online system 110 using a brand page associated with the entity's user profile. Other users of the online system 110 may connect to the brand page to receive information posted to the brand page or to receive information from the brand page. A user profile associated with the brand page may include information about the entity itself, providing users with background or informational data about the entity.

The social content store 244 stores objects that each represents various types of social content. Examples of social content represented by an object include a page post, a status update, a photograph, a video, a link, a shared content item, a gaming application achievement, a check-in event at a local business, a brand page, or any other type of content. Online system users may create objects stored by the social content store 244, such as status updates, photos tagged by users to be associated with other objects in the online system 110, events, groups or applications. In some embodiments, objects are received from third-party applications or third-party applications separate from the online system 110. In one embodiment, objects in the content store 244 represent single pieces of social content, or social content “items.” Hence, users of the online system 110 are encouraged to communicate with each other by posting text and social content items of various types of media through various communication channels. This increases the amount of interaction of users with each other and increases the frequency with which users interact within the online system 110.

The action logger 216 receives communications about user actions internal to and/or external to the online system 110, populating the action log 252 with information about user actions. Examples of actions include adding a connection to another user, sending a message to another user, uploading an image, reading a message from another user, viewing social content associated with another user, attending an event posted by another user, among others. In addition, a number of actions may involve an object and one or more particular users, so these actions are associated with those users as well and stored in the action log 252.

The action log 252 may be used by the online system 110 to track user actions on the online system 110, as well as actions on third party systems that communicate information to the online system 110. Users may interact with various objects on the online system 110, and information describing these interactions is stored in the action log 252. Examples of interactions with objects include commenting on posts, sharing links, and checking-in to physical locations via a mobile device, accessing content items, and any other interactions. Additional examples of interactions with objects on the online system 110 that are included in the action log 252 include commenting on a photo album, communicating with a user, establishing a connection with an object, joining an event to a calendar, joining a group, creating an event, authorizing an application, using an application, expressing a preference for an object (“liking” the object) and engaging in a transaction. In some embodiments, data from the action log 252 is used to infer interests or preferences of a user, augmenting the interests included in the user's user profile and allowing a more complete understanding of user preferences.

The action log 252 may also store user actions taken on a third party system, such as an external website, and communicated to the online system 110. For example, an e-commerce website may include a reference to the online system 110 through a social plug-in or a reference to the online system 100, enabling the online system 100 to identify when users visit the e-commerce website and identify actions performed there. The online system 100 may identify a particular user of the online system 110 to associate with the actions. This permits the e-commerce websites to communicate information about a user's actions outside of the online system 110 to the online system 110 for association with the user. Hence, the action log 252 may record information about actions users perform on a third party system, including webpage viewing histories, conversion actions for content items, purchases made, and other patterns from user interactions across various external systems. Though described as relating to a user of the online system 110, the user profiles and other user information may be determined for individuals based on user activity across different external systems, though the user may not have self-declared information on a profile in the online system 110.

The edge store 240 stores information describing connections between users and other objects on the online system 110 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 110, such as expressing interest in a page on the online system 110, sharing a link with other users of the online system 110, and commenting on posts made by other users of the online system 110.

The web server 220 links the online system 110 via the network 120 to the one or more client devices 116, as well as to the one or more third party systems. The web server 220 serves web pages, as well as other web-related content, such as JAVA®, FLASH®, XML and so forth. The web server 220 may receive and route messages between the online system 110 and the client device 116, for example, instant messages, queued messages (e.g., email), text messages, short message service (SMS) messages, or messages sent using any other suitable messaging technique. A user may send a request to the web server 220 to upload information (e.g., images or videos) that are stored in the social content store 244. Additionally, the web server 220 may provide application programming interface (API) functionality to send data directly to native client device operating systems, such as IOS®, ANDROID™, WEBOS® or RIM®.

The content selection subsystem 212 selects and provides content items for users. The various content items are selected by the content selection subsystem 212 for placement on the limited display space of a user's device. From many content items that could be presented to a user, the content selection subsystem 212 selects those that are likely of interest to the user or otherwise present a high expected value. When an individual user requests content items, the content selection subsystem 212 identifies content items eligible for presentation to the user and selects from among the eligible content items. Accordingly, each content item may specify which users are eligible to receive the content item (“target users”). These target users may defined as a specific set of users (e.g., users A, B, and C) or may be identified based on a set of characteristics (e.g., users that like baseball), which is used to identify a specific set of users (e.g., users X, Y, and Z like baseball). When a requesting user is a target user for a content item, that content item is eligible for presentation to that requesting user and is considered for selection to the user as further discussed below.

To better target users for a content item, the content selection subsystem 212 may target a content item to users who are identified to have high incremental likelihoods of performing a conversion action for the content item when presented with the content item. The conversion actions are user actions identified by the online system 110 or the content providers 114 that are desired by the sponsoring entities, and which may represent user interest in the sponsoring entities. For example, conversion actions may promote purchasing of various products, and may occur when a user purchases a product of the sponsoring entity through the website of the entity. As another example, conversion actions may promote user engagement to the online system 110, and may occur when a user expands his/her connections to other users of the online system 110, invite new users to the online system 110, and post social content on the online system 110.

The incremental likelihood represents the difference between the response likelihood of performing conversion actions when a content item is presented to a user, and the baseline likelihood when a content item is not presented to the user. The baseline and response likelihood for a user are predicted by one or more machine-learned models and used to determine a set of target users for the content item. The incremental likelihood represents the increase in likelihood that the user will perform the conversion action after viewing the content item compared to when the user has not viewed the content item. Thus, the incremental likelihood also represents the impact of the content item on the user to perform the conversion action.

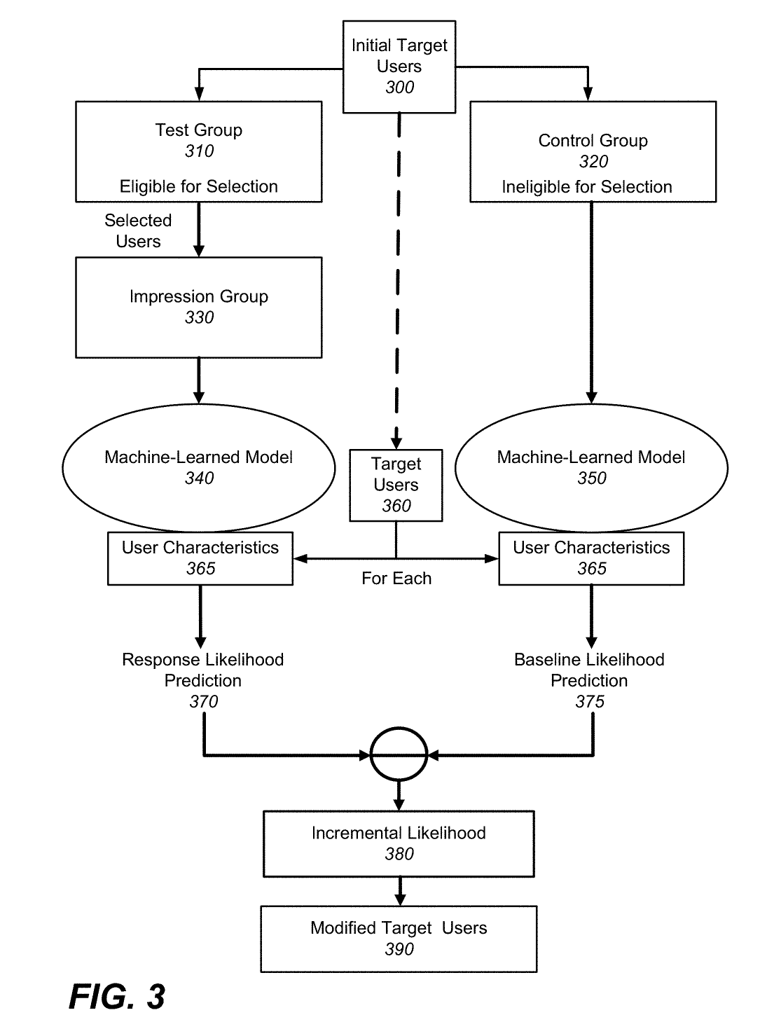

FIG. 3 is an example process of determining incremental likelihoods for users of the online system 110 for a content item. This process may be performed by various components of the content selection system 212 as further discussed below. The content selection subsystem 212 identifies a control group 320 of users and an impression group 330 of users from the online system 110. The content item is provided to the impression group, and is not provided to users in the control group. In some embodiments, the content selection subsystem 212 identifies a test group 310 from which the impression group 330 is identified based on the users that were provided the content item from the test group 310. In this example, some users in the test group 310 receive the content item, for example when the content item competes with other content items for placement to a user. When the content item is actually placed and displayed to a user in the test group 310, that user may be considered a member of the impression group 330. In other examples, the content item is automatically provided to users of the test group 310, in which case the impression group 330 may be all users in the test group 310. Consequently, the content items are selected for display to a subset of users in the test group (“impression group”).

In some embodiments, an initial set of target users 300 (e.g., as determined by targeting criteria) is identified and used for the selection of the test group 310 and the control group 320. The test group 310 and control group 320 may be selected from among the initial target users 300, for example by designating a portion of the target users 300 to each group.

Conversion actions are received for members of the impression group 330 and the control group 320. For each group, one or more machine-learned models 340, 350 are trained based on the conversion actions of users and the user characteristics of the users in each group. Specifically, the machine-learned models predict the likelihood that a conversion action will occur based on given user characteristics. The predicted likelihood for the model 340 trained on the impression group is termed a response likelihood prediction 370, and the predicted likelihood for the model trained on the control group is termed a baseline likelihood prediction 375.

Using the models 340, 350, the incremental likelihood of performing the action is determined for target users 360. The target users 360 may be the initial target users 300, or may be selected from the test group 310, the control group 320, or the impression group 330. For each of the target users 360, a response likelihood prediction 370 is determined by applying a user's characteristics 365 to the machine learned model 340, and a baseline likelihood prediction 375 is determined by applying the user's characteristics 365 to the machine learned model 350. The difference in predicted likelihoods for each of the target users 360 is identified as the predicted incremental likelihood 380.

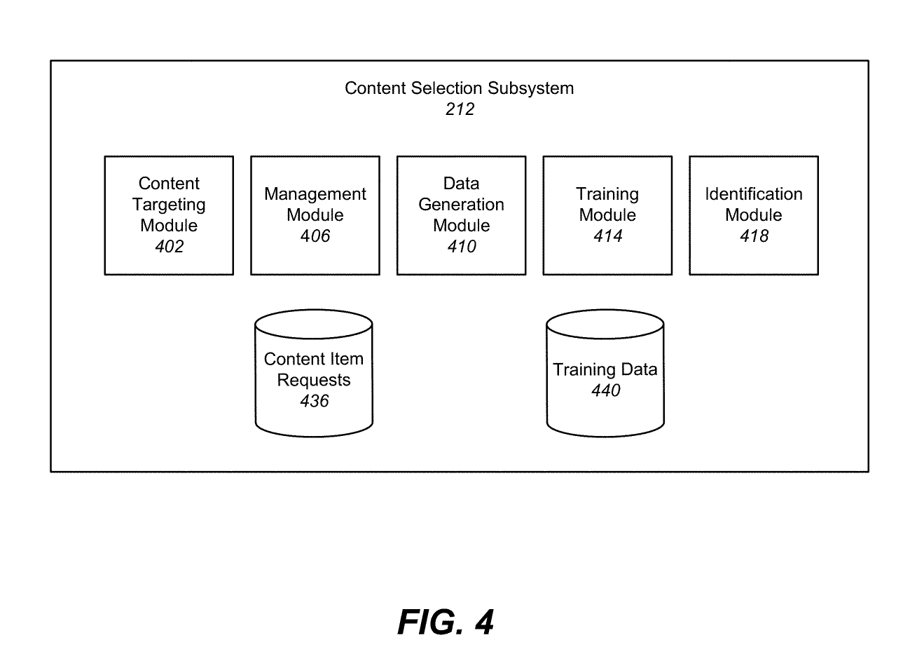

After determining the incremental likelihoods, the content selection subsystem 212 determines a modified targeting for the content item using the incremental likelihoods 380. For example, by identifying users having incremental likelihoods meeting predetermined criteria or by identifying modified target users 390 who have characteristics similar to those users with certain incremental likelihoods. By doing so, the content selection subsystem 212 provides content items to users whose likelihood of conversion actions are more likely to be impacted by the presentation of content items. A more detailed embodiment of the content selection subsystem 212 is provided below in conjunction with FIG. 4.

### Content Selection Subsystem

FIG. 4 is an example block diagram of an architecture of the content selection subsystem 212, in accordance with an embodiment. The content selection subsystem 212 shown in FIG. 4 includes a content targeting module 402, a management module 406, a data generation module 410, a training module 414, and an identification module 414. The content selection subsystem 212 also includes content item requests 436 and training data 440.

The content item requests 436 store requests to present content items to users of the online system 110. A content item request 436 includes the content item, and any other information associated with the content item, such as a specified value for presenting the content item or a value for the user performing the action, in addition to initial target users of the content item. The value for a content item may be represented as a bid amount or a budget for the content item. As described above, a content item in content item requests 436 is associated with desired actions performed by users of the online system 110 in response to viewing the content item that the content provider 114 has identified as being valuable to the entity associated with the content item. The initial target users are users identified by the content provider 114 from whom the conversion actions are desired. For example, initial target users for a content item promoting purchase of baseball gloves may be users of the online system who have been identified to like baseball, as the frequency of the conversion actions among these users are likely to be higher than other users. In other embodiments, the online system 110 may identify initial target users instead of the content providers 114.

The content item is text, image, audio, video, or any other suitable data presented to a user that promotes the desired actions associated with the content item. As an example, a content item promoting purchase of baseball gloves may include advertisements in the form of images, videos, and the like. As another example, a content item promoting user engagement to the online system 110 may include social networking items that recommended connections to other users based on user characteristics, suggestions to post content identified to be recently created in a mobile device connected to the user, and the like. In various embodiments, the content also includes a landing page specifying a network address to which a user is directed when the item is accessed.

The content targeting module 402 identifies a presentation opportunity for a user of a client device 116 to be presented with one or more content items, and identifies one or more candidate items in content item requests 436 from which to select one or more content items for delivery in response to the presentation opportunity. Responsive to a request from a client device 116 for a content item, the content targeting module 402 selects a content item to serve to the client device 116 among the candidate items. In one embodiment, the content targeting module 402 provides content items to users of the initial target users. In one embodiment, the target users for a content item are identified (or modified) based on the predicted incremental likelihood of users performing the conversion action after receiving the content item.

In one instance, the content targeting module 402 performs competition, such as an auction process, based on the value associated with each candidate content item request 436 to select a content item with the highest value. This value may be represented as a bid in an auction process, or may otherwise represent the desirability of placing the content item to the user requesting the content item. The value may be determined based on a predicted likelihood of the user interacting with the content item or of performing a desired action of the content item. For example, the value may be determined by multiplying the desirability of placing the content item by the likelihood of the user performing a desired conversion action. In another embodiment, the value may be determined based on a predicted incremental likelihood of the user performing a desired action of the content item. For example, the value may be determined by multiplying the desirability of placing the content item by the predicted incremental likelihood of the user performing a desired conversion action.

To determine the predicted incremental likelihood for a user and determine the modified target users, additional modules of the content selection subsystem 212 identify control and impression groups, train computer models, and identify target users for the content item. Though described in relation to a single content item for clarity, this process may be performed for many content items at a given time.

The management module 406 identifies a control group of users and a test group of users from the online system 110, and requests the content targeting module 402 to provide content items associated with the content providers 114 to users of the test group. In some examples, the targeting criteria for the content targeting module 406 is modified to include the test group and exclude the control group, such that the test group competes with other content items for placement to users. Consequently, the content items may be selected for display to a subset of users in the test group (forming the “impression group” that actually received the content item). In one embodiment, the management module 406 randomly selects users for the control group and the test group among all users of the online system 110. In another embodiment, the management module 406 randomly selects users for the control group and the test group within a population of users identified by predetermined criteria. For example, the management module 406 may select users for the control group and the test group among users specified in as initial target users, such as those users that meet an initial targeting criteria.

The data generation module 410 generates training data 440 that contains information on whether a user is assigned to the control group or the impression group, whether the user performed conversion actions, and characteristics of the user that may be predictive of the conversion actions. The training data 440 is later used by the training module 410 to learn predictive relationships between user characteristics and conversion actions associated with the sponsoring entities. Specifically, the data generation module 410 collects information for the training data from the user profile store 236, edge store 240, content store 244, and the action log 252.

The data generation module 410 identifies conversion actions as user actions recorded in the action log 252 that indicate whether users have performed the conversion action associated with the content item.

The conversion actions for users in the impression group are identified among actions occurring after the users were presented with the content item, and the conversion responses for users in the control group are identified among actions occurring without the presentation of content item. In one embodiment, the data generation module 410 may identify conversion actions from user actions that occurred within a predetermined amount of time from presenting the content item. For example, the data generation module 410 may identify conversion actions for a test group user among user actions occurring during a 1-hour window of time after the user was presented with the content item.

The data generation module 410 indicates whether a user performed desired actions in the form of conversion responses in the training data 440. The conversion responses may be discrete or continuous values. For example, a conversion response for a user may be a binary value in the set of {0, 1}, where a positive conversion response of “1” indicates that the user performed a conversion action, and a negative conversion response of “0” indicates that the user did not perform any conversion action during a predetermined amount of time. As another example, a conversion response may be a continuous value in the set of [0, 1], indicating the frequency of conversion actions performed by the user in a predetermined amount of time.

The data generation module 410 also collects characteristics of users that may be predictive of conversion actions of the users in the form of user attributes in the training data 440. The set of attributes may be indicated as discrete or continuous values. Attributes may include demographic characteristics of users, such as gender, hometown, age, and the like. Attributes may also include social characteristics of users, such as whether the users have interacted with a profile of a sponsoring entity, whether the social network of the users contain users that have performed the conversion action or purchased a product of a sponsoring entity, and the like. Attributes may also include action characteristics of users, such as whether the users have previously performed a similar action or purchased a product at a website of a sponsoring entity.

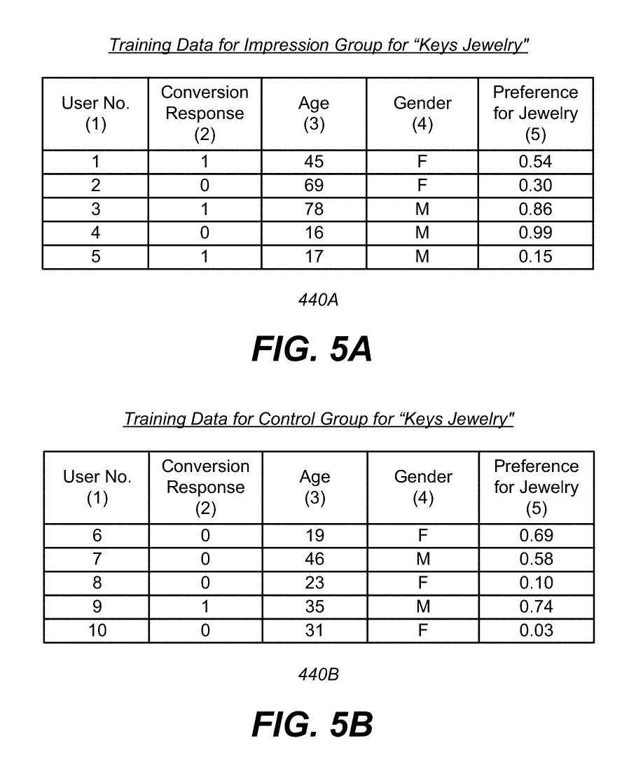

FIGS. 5A and 5B illustrate example training data 440A, 440B for an impression group and a test group, in accordance with an embodiment. In this example, the content item may be sponsored by content provider 114, and the value of the content item may represent a user viewing a specific product at the content provider 114. As shown in FIG. 5A, an example subset of the training data 440A for the impression group includes information for 5 users, each of whom were presented with the content item associated with the content provider 114. Values in Column 2 are binary conversion responses for each user that indicate whether each user purchased a “Keys Jewelry” product from, for example, the website of the content provider 114. Values in Columns 3, 4, 5 are attributes for each user that may be predictive of conversion actions of each user. The three example attributes include the age, gender, and preference for jewelry on the online system 110.

The training module 414 constructs one or more machine-learned models based on the training data 440 that predict, for a given set of attributes for a user, a response likelihood indicating the likelihood of conversion actions when the user is presented with content items, and a baseline likelihood indicating the likelihood of user actions when the user is not presented with the content items. The machine-learned models predict the baseline likelihoods by identifying the relationship between conversion responses and user attributes in the training data of the control group, and predict the response likelihoods by identifying the relationship in the training data of the impression group.

The machine-learned models also provide insight into which user characteristics are indicative of conversion actions when users are presented and are not presented with content items. For example, for the content provider 114 “Keys Jewelry,” the models may identify that female users in the age group of 20-25 have a high rate of conversion responses from the training data associated with the control group, leading to high baseline likelihoods for other similar users, and identify that female users in the age group of 20-25 and 40-50 have a high rate of conversion responses from the training data associated with the impression group, leading to a high response likelihood for other similar users. This may indicate that females of the age group of 20-25 are likely to purchase jewelry from the content provider 114 regardless of whether or not the users were presented with content items, and females of the age group of 40-50 are more likely to purchase jewelry from the content provider 114 when presented with content items.

In one embodiment, the training module 414 constructs two different machine-learned models respectively trained on the training data for the control group and the impression group. In another embodiment, the training module 414 constructs a single machine-learned model. In one instance, the machine-learned models are decision-tree based models, such as gradient-boosted decision trees, random forests, and the like. In another instance, the machine-learned models are neural-network based models such as artificial neural networks (ANN), convolutional neural networks (CNN), deep neural networks (DNN), and the like. In yet another instance, the machine-learned models are linear additive models such as linear regression models, logistic regression models, support vector machine (SVM) models, and the like.

The identification module 418 identifies target users whose conversion actions are significantly impacted by the presentation of content items, for example to set target users for the content item or modify an initial set of target users. Initially, the identification module 418 applies the machine-learned models to the set of attributes for one or more users of the online system 110 to predict baseline likelihoods and response likelihoods for the one or more users. These one or more users may be the initial target users, selected from the control and target group users, or may be selected more generally from users of the online system 110. Subsequently, the identification module 418 determines the incremental likelihoods of the one or more users by calculating the difference between the predicted response likelihood and baseline likelihood of each user. Thus, the incremental likelihood represents the incremental impact of the content item on whether a user will perform conversion actions when the user is and is not presented with the content item.

The identification module 418 identifies target users having incremental likelihoods meeting predetermined criteria by ranking the one or more users according to the determined incremental likelihoods. In one embodiment, a predetermined number or percentage (e.g., 25%) of users having the highest incremental likelihoods are identified and used to select target users. The group of high incremental users (i.e., those with the “highest incremental likelihood”) may also be determined based on whether the average incremental likelihood among the group of highest incremental users is greater than the average incremental likelihood among the remaining users. The average incremental likelihood for a group of users may be calculated by, for example, taking the difference in the average baseline likelihood of users in the group and the average response likelihood of users in the group.

In another embodiment, the group of high incremental users is determined based on whether the ratio of the average incremental likelihood to the average spending for the target users is greater than the ratio of the average incremental likelihood to the average spending for the remaining users. The average spending for a group of users is the estimated spending may be determined by the actions performed by converting users, such as those that directly generate revenue (e.g., to a content provider 114).

In some embodiments, the group of high incremental users is used as the new target users of the content item, such as when the group of users for which a likelihood is predicted are not selected from the impression group. In another example, the target users are determined based on the group of high incremental likelihood, for example to identify common user characteristics of the group of high incremental users and target other users that include the common user characteristics. In another embodiment, the identification module 418 identifies look-alike users that share similar characteristics to the target users based on the attribute values of the target users. These “look-alike” users may be determined, for example, by clustering users in the high incremental likelihood group according to user characteristics and generating a training model for the clustered users to predict membership in the cluster. Users predicted as having a sufficient confidence of belonging to the cluster may be selected as “look-alike” users to the high incremental likelihood users, and selected as the modified target users. The threshold confidence level (of similarity to the cluster) for inclusion as a target user may be adjusted upwards or downwards to increase or decrease the number of users in the group of target users. Additional details for selecting such “look-alike” users is described in U.S. application Ser. No. 13/297,117, filed Nov. 15, 2011, which is hereby incorporated by reference.

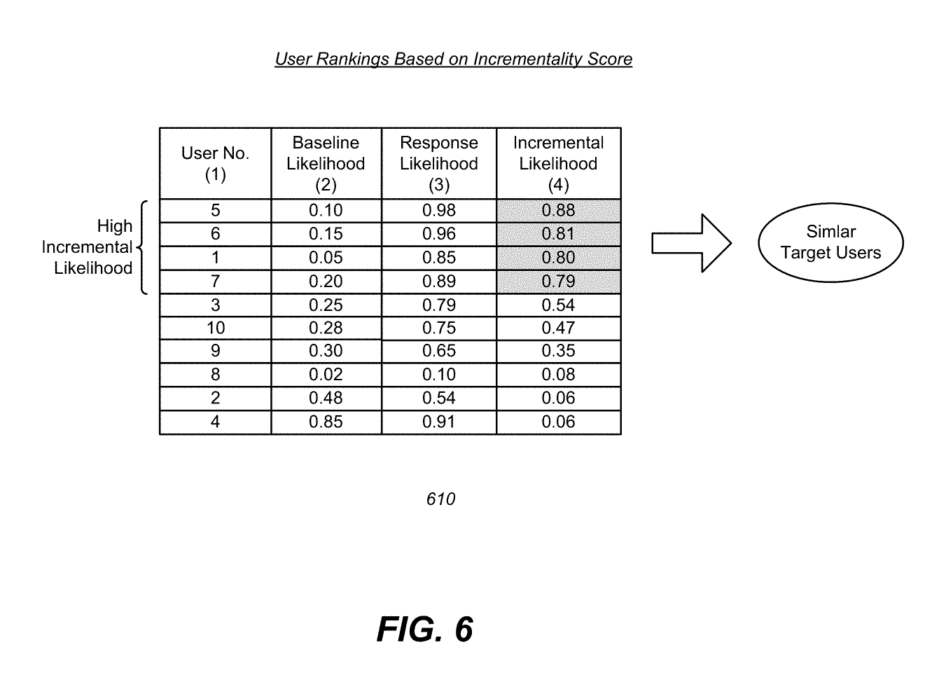

FIG. 6 shows example data of predicted baseline likelihoods, response likelihoods, and incremental likelihoods for users of the online system 110. As shown in FIG. 6, the users are ranked according to the value of their incremental likelihood. In this example, Users 5, 6, 1, 7 are identified as having high incremental likelihood. As indicated by the relatively high values of incremental likelihood, the these users have a significant difference between the baseline likelihood and the response likelihood that indicates that the users may not be likely to perform conversion actions in the absence of the content item, but predicted to be significantly more likely to perform conversion actions when presented with the content item.

As one user not included in the high incremental users, the incremental likelihood for user no. 4 is the lowest as the baseline likelihood and response likelihood are both significantly high, indicating that the user will perform conversion actions regardless of whether content items are presented to the user. As another example, the incremental likelihood for user no. 8 is also relatively low as the baseline likelihood and response likelihood are both significantly low. This indicates that the user will likely not perform any conversion actions regardless of whether content items are presented to the user.

Assuming these users were members of the content item's initial target users, these users illustrate the significance of identifying incremental likelihoods—User 4 may have previously been targeted by the content item as high-value (and increase the associated value of selecting the content item) because a conversion action would be likely to occur, while User 4 did not need the content item to cause it to occur in effect causing placement of a content item that appeared high-value but actually did not impact conversion significantly, while User 8 is predicted to be poorly targeted by the content item and is unlikely to perform the conversion action even after an impression.

From the high incremental likelihood users, target users for the content item are selected, such as those similar to these users or by identifying look-alike users that retain similar attribute values with the high incremental likelihood users.

The identification module 418 requests the content targeting module 402 to set targeting of the content item to the target users identified by the content targeting module 402. By doing so, the content selection subsystem 212 provides content items to users whose conversion actions are significantly impacted by the presentation of content items.

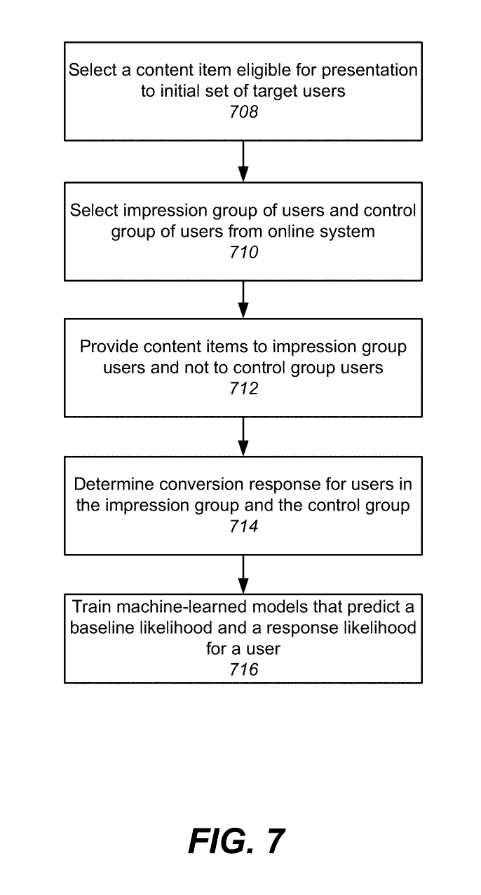

FIG. 7 is a flowchart illustrating a process of training machine-learned models for predicting baseline and response likelihoods, in accordance with an embodiment.

The online system identifies 708 a content item eligible for presentation to an initial set of target users of the online system. The content item is associated with a desired conversion action. The online system selects 710 an impression group of users and a control group of users from one or more users of the online system. The online system provides 712 content items to users of the impression group, and does not provide the content item to users of the control group. For each user in the impression group and the control group, the online system determines 714 a conversion response indicating whether the user performed the desired conversion action associated with the content item. The online system trains 716 one or more machine-learned models based on the identified conversion responses. The machine-learned models predict a baseline likelihood a user will perform the conversion actions when the user is not presented with the content item, and a response likelihood a user will perform the conversion actions when the user is presented with the content item.

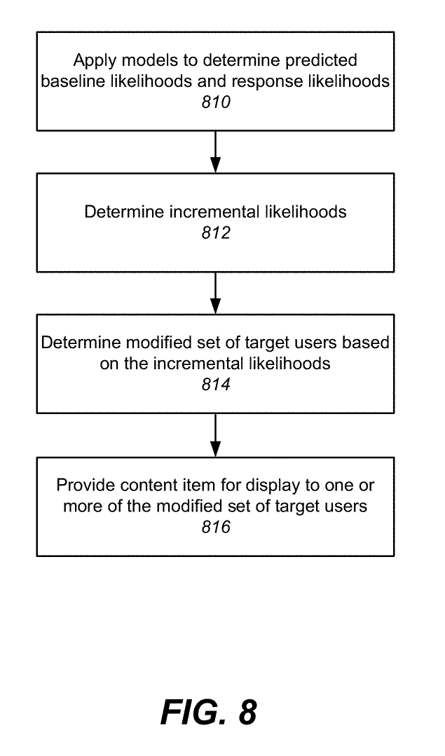

FIG. 8 is a flowchart illustrating a process of providing content items to users having high incremental likelihoods, in accordance with an embodiment.

The online system applies 810 the machine-learned models trained in the flowchart of FIG. 7 to each of one or more users of the online system to determine a predicted baseline likelihood and response likelihood for each user. For each user, the online system determines 812 an incremental likelihood of the user by taking the difference between the predicted response likelihood and the baseline likelihood. The online system determines 814 a modified set of target users for the content item from the one or more users based on the determined incremental likelihoods. The online system provides 816 the content items for display to one or more of the modified set of target users.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying a content item eligible for presentation to an initial set of target users of an online system, the content item associated with a desired conversion action;
selecting an impression group of users and a control group of users from the initial set of target users;
providing a content item to users of the impression group, where the content item is not provided to users of the control group;
determining, for each user in the impression group and each user in the control group, a conversion response indicating whether the user performed the desired action;
training one or more machine-learned models based on the identified conversion responses that predict a baseline likelihood a user will perform the conversion actions when the user is not presented with the content item, and a response likelihood a user will perform the conversion actions after the user is presented with the content item;
for each of one or more users in the initial set of target users,
applying the machine-learned models to generate a baseline likelihood for the user,
applying the machine-learned models to generate a response likelihood for the user, and
generating an incremental likelihood of the user performing the conversion actions when provided with the content item by calculating the difference between the response likelihood and the baseline likelihood for the user;
determining a modified set of target users for the content item from the one or more users based on the incremental likelihoods of the one or more users; and
providing the content item for display to one or more of the modified set of target users.

2. The method of claim 1, wherein the incremental likelihoods of each target user is above a predetermined threshold.

3. The method of claim 1, wherein an average incremental likelihood of the target users is higher than an average incremental likelihood of the remaining users from the one or more users that are not the target users.

4. The method of claim 1, wherein a ratio of an average incremental likelihood to average spending for the target users is higher than a ratio of an average incremental likelihood to average spending for the remaining users from the one or more users that are not the target users.

5. The method of claim 1, wherein the modified set of target users is determined based on user characteristics of a group of the one or more users identified to have incremental likelihoods meeting a predetermined criteria.

6. The method of claim 1, wherein training the one or more machine-learned models comprises:
training a first machine-learned model based on the identified conversion responses of users in the control group; and
training a second machine-learned model based on the identified conversion responses of users in the impression group.

7. The method of claim 1, wherein selecting the impression group of users comprises:
selecting a test group of users from the initial set of target users, the test group of users eligible for receiving the content item;
providing the content item to compete with other content items for placement on devices associated with the test group of users; and
selecting the impression group of users as users for whom the content items were selected for placement in the competition.

8. A computer-readable medium containing instructions for execution on the processor, the instructions comprising:
identifying a content item eligible for presentation to an initial set of target users of an online system, the content item associated with a desired conversion action;
selecting an impression group of users and a control group of users from the initial set of target users;
providing a content item to users of the impression group, where the content item is not provided to users of the control group;
determining, for each user in the impression group and each user in the control group, a conversion response indicating whether the user performed the desired action;
training one or more machine-learned models based on the identified conversion responses that predict a baseline likelihood a user will perform the conversion actions when the user is not presented with the content item, and a response likelihood a user will perform the conversion actions after the user is presented with the content item;
for each of one or more users in the initial set of target users,
applying the machine-learned models to generate a baseline likelihood for the user,
applying the machine-learned models to generate a response likelihood for the user, and
generating an incremental likelihood of the user performing the conversion actions when provided with the content item by calculating the difference between the response likelihood and the baseline likelihood for the user;
determining a modified set of target users for the content item from the one or more users based on the incremental likelihoods of the one or more users; and
providing the content item for display to one or more of the modified set of target users.

9. The computer-readable medium of claim 8, wherein the incremental likelihoods of each target user is above a predetermined threshold.

10. The computer-readable medium of claim 8, wherein an average incremental likelihood of the target users is higher than an average incremental likelihood of the remaining users from the one or more users that are not the target users.

11. The computer-readable medium of claim 8, wherein a ratio of an average incremental likelihood to average spending for the target users is higher than a ratio of an average incremental likelihood to average spending for the remaining users from the one or more users that are not the target users.

12. The computer-readable medium of claim 8, wherein the modified set of target users is determined based on user characteristics of a group of the one or more users identified to have incremental likelihoods meeting a predetermined criteria.

13. The computer-readable medium of claim 8, wherein training the one or more machine-learned models comprises:
training a first machine-learned model based on the identified conversion responses of users in the control group; and
training a second machine-learned model based on the identified conversion responses of users in the impression group.

14. The computer-readable medium of claim 8, wherein selecting the impression group of users comprises:
selecting a test group of users from the initial set of target users, the test group of users eligible for receiving the content item;
providing the content item to compete with other content items for placement on devices associated with the test group of users; and
selecting the impression group of users as users for whom the content items were selected for placement in the competition.

15. A system comprising:
a processor configured to execute instructions;
a computer-readable medium containing instructions for execution on the processor, the instructions causing the processor to perform steps of:
identifying a content item eligible for presentation to an initial set of target users of an online system, the content item associated with a desired conversion action;
selecting an impression group of users and a control group of users from the initial set of target users;
providing a content item to users of the impression group, where the content item is not provided to users of the control group;
determining, for each user in the impression group and each user in the control group, a conversion response indicating whether the user performed the desired action;
training one or more machine-learned models based on the identified conversion responses that predict a baseline likelihood a user will perform the conversion actions when the user is not presented with the content item, and a response likelihood a user will perform the conversion actions after the user is presented with the content item;
for each of one or more users in the initial set of target users,
applying the machine-learned models to generate a baseline likelihood for the user,
applying the machine-learned models to generate a response likelihood for the user, and
generating an incremental likelihood of the user performing the conversion actions when provided with the content item by calculating the difference between the response likelihood and the baseline likelihood for the user;
determining a modified set of target users for the content item from the one or more users based on the incremental likelihoods of the one or more users; and
providing the content item for display to one or more of the modified set of target users.

16. The system of claim 15, wherein the incremental likelihoods of each target user is above a predetermined threshold.

17. The system of claim 15, wherein an average incremental likelihood of the target users is higher than an average incremental likelihood of the remaining users from the one or more users that are not the target users.

18. The system of claim 15, wherein a ratio of an average incremental likelihood to average spending for the target users is higher than a ratio of an average incremental likelihood to average spending for the remaining users from the one or more users that are not the target users.

19. The system of claim 15, wherein the modified set of target users is determined based on user characteristics of a group of the one or more users identified to have incremental likelihoods meeting a predetermined criteria.

20. The system of claim 15, wherein selecting the impression group of users comprises:
selecting a test group of users from the initial set of target users, the test group of users eligible for receiving the content item;
providing the content item to compete with other content items for placement on devices associated with the test group of users; and
selecting the impression group of users as users for whom the content items were selected for placement in the competition.
